(19) United States
(12) Patent Application Publication
(10) Pub. No.: US 2003/0215600 A1
(43) Pub. Date: Nov. 20, 2003

(54) Child seat protector

(76) Inventor: Caron Ammons, Lawrenceville, GA (US)

Correspondence Address: Caron Ammons, 1400 Walnut Hill Circle, Lawrenceville, GA, 30043, US

(21) Appl. No.: 10/151,373

(22) Filed: May 20, 2002

(51) Int. Cl. B32B 3/06

(52) U.S. Cl. 428/102; 428/85

(57) ABSTRACT

A sheet of porous material, a sheet of absorptive material, and a sheet of non-porous material connected to the porous sheet with the absorptive sheet between them. The sheets are shaped to cover a seat surface of a child seat such as an car seat, and have a seat panel, two leg panels that extend from the seat panel, and a crotch flap that extends from the seat panel between the two leg panels. The porous material permits urine from a child in the child seat to pass through it, the absorptive material absorbs the urine, and the non-porous material prevents the urine from leaking through the absorptive sheet and soiling the child seat.

### TECHNICAL FIELD

The present invention relates generally to child seats such as car seats and, more particularly, to an absorptive cover for a child seat that protects it from urine in the event the child wets himself.

### BACKGROUND OF THE INVENTION

Car seats are regularly used to safely transport children in automobiles. Children are prone to wet themselves accidentally. For very young children in diapers, their urine is mostly contained within the diaper. But for children who are being potty-trained by their parents and thus who are not wearing diapers, their urine leaks through their clothing and soils the car seat. Then the parents have to uninstall the car seat from the car to wash the soiled seat. This poses a dilemma for parents: whether to permit their car seat to become unsanitary and to endure the hassle of frequently washing it, or whether to keep their children in diapers longer than would otherwise be necessary. Of course, the same dilemma arises with respect to many other child seats, including strollers, cribs, end chairs, high chairs, or even the child's favorite sofa or arm-chair.

Accordingly, it can be seen that there is a need for a way to protect child seats from being soiled by children's urine so that their parents can dress them without diapers to facilitate early potty-training. A need further exists for such a child seat protector that can be easily removed for periodic cleaning. Additionally, there is a need for such a child seat protector that can be used with car seats and other child seats, and that is economical to make and sell. It is to the provision of a car seat protector meeting these and other needs that the present invention is primarily directed.

### SUMMARY OF THE INVENTION

The present invention is a protector for an child seat that can be placed on a seat surface of the child seat to protect it from soiling by urination from a child. The child seat protector can be used with a variety of child seats, including car seats, strollers, cribs, end chairs, high chairs, sofas, or arm-chairs. The child seat protector can be placed on the child seat for use and then removed at some later time for washing. By using the child seat protector, parents can better and earlier potty-train their children by dressing them without diapers for everyday activities including transporting them in their cars.

Briefly described, the child seat protector includes a sheet of absorptive material that absorbs urine from a child in the child seat and a sheet of non-porous material that prevents the urine from leaking through the absorptive sheet and soiling the child seat. The absorptive sheet and the non-porous sheet are shaped to cover at least a portion of the seat surface to catch and absorb the urination from the child.

In a first exemplary embodiment, the child seat protector includes a sheet of porous material that permits the child's urine to pass through it so that it can be absorbed by the absorptive sheet. The absorptive sheet is positioned between and stitched or otherwise coupled to the porous sheet and the non-porous sheet.

The porous sheet, the absorptive sheet, and the non-porous sheet each have a seat panel, two leg panels extending from the seat panel, and a crotch flap extending from the seat panel and disposed between the two leg panels. The non-porous sheet has a bottom surface with a texture or protrusions or that otherwise provides high frictional characteristics to prevent it from slipping against the seat surface so that it stays in place.

Additionally, the porous sheet, the absorptive sheet, and the non-porous sheet each have a body portion with a similar shape and size, the porous sheet and the non-porous sheet each have an edge portion with a similar shape and size, and the absorptive sheet has a plurality of edge tabs extending from the absorptive sheet body portion. In this arrangement, the porous sheet edge portion, the absorptive sheet edge tabs, and the non-porous sheet edge portion can be coupled together, for example, by stitching. Because the absorptive sheet is smaller than the porous sheet and the non-porous sheet, the material costs of making the protector are minimized.

In a second exemplary embodiment, the child seat protector includes a back panel that extends from the seat panel opposite the leg panels. In this arrangement, the protector provides for increased comfort for the child's-back while also protecting the child seat.

These and other objects, features, and advantages of the present invention will become more apparent upon reading the following description in conjunction with the accompanying drawing figures.

### BRIEF DESCRIPTION OF THE DRAWING FIGURES

FIG. 1 is a perspective view of a child seat protector according to a first exemplary embodiment of the invention, showing the child seat protector in use with a car seat.

FIG. 2 is a plan view of the child seat protector of FIG. 1, showing the seat panel, the leg panels, and the crotch flaps.

FIG. 3 is a cross section view of the child seat protector taken at line 3-3 of FIG. 2, showing the porous sheet edge, the absorptive sheet tabs, and the non-porous sheet edge connected together.

FIG. 4 is a cross section view of the child seat protector taken at line 4-4 of FIG. 2, showing the porous sheet edge and the non-porous sheet edge connected together between the absorptive sheet tabs.

FIG. 5 is a plan view of a child seat protector according to a second exemplary embodiment of the invention, showing a back panel extending from the seat panel.

### DETAILED DESCRIPTION OF THE EXEMPLARY EMBODIMENTS

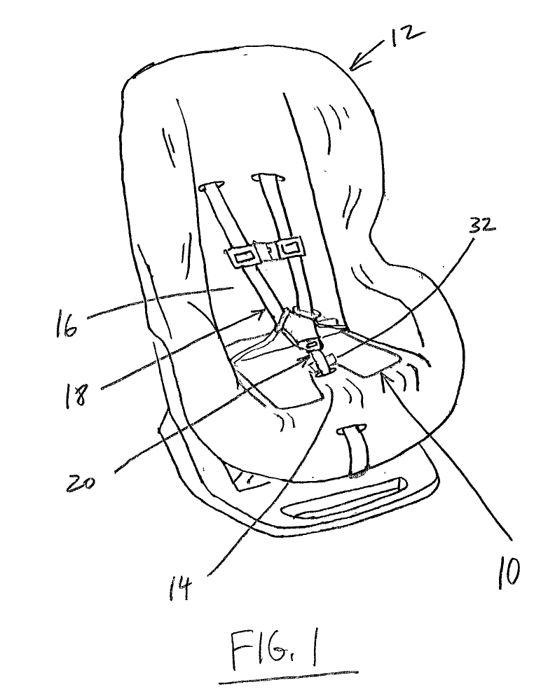

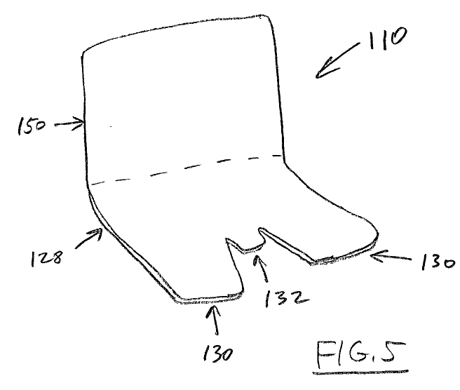

Referring now to the drawing figures, wherein like reference numerals represent like parts throughout the several views, FIGS. 1-5 show a first exemplary embodiment of the present invention, generally referred to as the child seat protector 10. In FIG. 1, the child seat protector 10 is shown in use with a car seat 12 for transporting a child in a car, truck, or other vehicle. The protector 10 can be used with conventional car seats 12 having a seat surface 14, a back surface 16, and a harness 18 including a crotch strap and buckle 20. It will be understood that the protector 10 can be used with a wide variety of such car seats 12, including those with different harness configurations with or without a crotch strap and buckle. In addition, the child seat protector 10 can be used with a variety of other types of child seats, including strollers, cribs, end chairs, high chairs, sofas or arm-chairs.

Referring additionally to FIGS. 2-4, the child seat protector 10 includes a sheet of porous material 22, a sheet of absorptive material 24, and a sheet of non-porous material 26. The sheets are connected together in a layered arrangement with the absorptive sheet 24 between the porous sheet 22 and the non-porous sheet 26.

The porous sheet 22 is made of a material selected to permit urine from a child in the car seat to pass through it, the absorptive sheet 24 is made of a material selected to absorb the urine, and the non-porous sheet 26 is made of a material selected to prevent the urine from leaking through it and soiling the car seat. For example, the porous sheet 22 can be made of a soft-to-the-touch, cushioning material such as terry cloth, the absorptive sheet 24 can be made of a non-woven cellulose material of the type commonly used in diapers, and the non-porous sheet 26 can be made of plastic and/or have a plastic lining. Alternatively, the protector can be made without the porous sheet 22 if the absorptive sheet 24 has sufficient wicking properties that it draws and keeps wetness away from the child's bottom. In any event, all of the constituent sheets are preferably made of machine-washable materials so that the protector 10 can be easily cleaned after becoming soiled.

The porous sheet 22, the absorptive sheet 24, and the non-porous sheet 26 are shaped to cover the seat surface 14 or at least the portion of it where the child sits. For example, the sheets 22, 24, and 26 may each have a seat panel 28, two leg panels 30 extending from the seat panel, and a crotch flap 32 extending from the seat panel between the two leg panels. Alternatively, the sheets 22, 24, and 26 can be provided without the leg panels 30 and/or without the crotch flap 32, in a generally rectangular, circular, or other regular or irregular shape, if so desired.

When installed in a car seat 12, the seat panel 28 and the leg panels 30 absorb and retain any urine or other fluid matter, from the child or elsewhere, to protect the seat surface 14 from being soiled. Also, the crotch flap 32 folds upward (see FIG. 1) to similarly protect the harness crotch strap and buckle 20. At the same time, the crotch flap 32 provides some cushioning between the child's crotch and the crotch strap and buckle 20, which makes for a more comfortable fit while the harness is fully tightened.

Additionally, the non-porous sheet 26 has a bottom surface 34 with high frictional characteristics to prevent slippage against the seat surface 14. For example, the frictional bottom surface 34 can have a texture, protrusions, both, or other surface structures for providing increased friction against the car seat surface 14.

The porous sheet 22, the absorptive sheet 24, and the non-porous sheet 26 can be coupled together by conventional techniques. For example, the sheets 22, 24, and 26 may be connected together by stitching 36. Alternatively, they can be connected together by binding with an adhesive, or by other means.

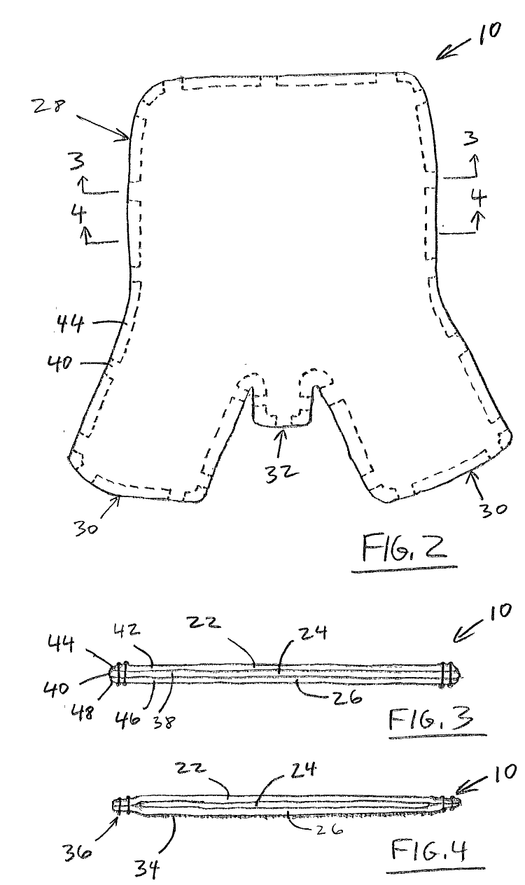

Before connecting the sheets 22, 24, and 26 together, the absorptive sheet can be cut or otherwise formed to minimize the amount of material required. In one way of doing this, the absorptive sheet 24 has a body portion 38 and is provided with edge tabs 40 extending from the body portion 38. Also, the porous sheet 22 has a body portion 42 and an edge portion 44 around its edges, and the non-porous sheet 26 has a body portion 46 and an edge portion 48 around its edges. The body portions 38, 42, and 46 have a similar shape and size, and the edge portions 44 and 48 have a similar shape and size. In this configuration, the porous and non-porous sheet edge portions 44 and 48 are connected together with the absorptive sheet edge tabs 40 between them (see FIG. 2). This secures the absorptive sheet 24 in place. And in between the edge tabs 40, the porous and non-porous sheet edge portions 44 and 48 are connected directly together (see FIG. 3). This eliminates unnecessary material around the edges.

In this way, the present invention provides a protector 10 that is economical to make and use, but at the same time is durable and washable so that it lasts a long time. The protector 10 can be installed on the car seat 12 for use, removed and machine-washed after a child has an accident on it, and then reinstalled. What's more, because of its lightweight construction, the parent can install and remove the protector 10 with one hand. Or the parent can reinstall the protector 10 on a stroller, crib, end chair, high chair, sofa, arm chair, other child seat, or other piece of furniture, as may be desired.

Referring now to FIG. 5, there is shown a second exemplary embodiment of the present invention, referred to generally as the protector 110. In this embodiment, the protector 110 is similar to that of the first embodiment, but it includes a back panel 150 extending from the seat panel 128 opposite the leg panels 130. In this arrangement, the back panel 150 may have one or more fasteners such as straps, snaps, clips, etc. for securing the back panel to the car seat so that it doesn't slip down. Additionally, the back panel 150 may include the porous sheet for providing additional padding and comfort to the infant. But it need not include an absorptive sheet or a non-porous backing sheet, unless it is for use with a child seat with a horizontal back surface for positioning the child lying down, such as a stroller or crib.

In any embodiment, the child seat protector can be made by cutting or otherwise forming the sheets into the shapes described herein, then coupling them together as described herein. Such assembly can be accomplished using conventional manufacturing techniques well known in the art.

Accordingly, the child seat protector prevents soiling of the child seat from a child's urine thereby permitting parents to dress their children in their underwear, without diapers, to aid in early potty-training. Additionally, the child seat protector can be positioned on the car seat so that it doesn't move around, and then easily removed when cleaning is needed. Furthermore, the child seat protector is economical to make and sell, and can be used on a wide variety of different car seats or other child seats.

While the invention has been shown and described in preferred forms, it will be apparent to those skilled in the art that many modifications, additions, and deletions can be made therein without departing from the spirit and scope of the invention as set forth in the following claims.

What is claimed is:

1. A removable protector for a child seat with a seat surface, the protector comprising:
a sheet of absorptive material shaped to cover at least a portion of the seat surface, wherein the absorptive material is selected to absorb urine from a child situated in the child seat; and
a sheet of non-porous material shaped to cover at least a portion of the seat surface and disposed below and coupled to the absorptive sheet, wherein the non-porous material is selected to prevent the urine from leaking through it and soiling the child seat.

2. The child seat protector of claim 1, wherein the absorptive sheet and the non-porous sheet each have a seat panel and two leg panels extending from the seat panel.

3. The child seat protector of claim 2, wherein the absorptive sheet and the non-porous sheet each have a crotch flap extending from the seat panel and disposed between the two leg panels.

4. The child seat protector of claim 2, further comprising a back panel extending from the seat panel opposite the leg panels.

5. The child seat protector of claim 1, wherein the non-porous sheet has a bottom surface with high frictional characteristics to prevent slippage against the seat surface.

6. The child seat protector of claim 1, further comprising a sheet of porous material disposed above and coupled to the absorptive sheet, wherein the porous material is selected to permit the urine to pass through it.

7. The child seat protector of claim 6, wherein the porous sheet, the absorptive sheet, and the non-porous sheet each have a body portion with a similar shape and size, the porous sheet and the non-porous sheet each have an edge portion with a similar shape and size, and the absorptive sheet has a plurality of edge tabs extending from the absorptive sheet body portion, wherein the porous sheet edge portion, the absorptive sheet edge tabs, and the non-porous sheet edge portion are coupled together.

8. A removable protector for a child seat with a seat surface, the protector comprising:
a sheet of porous material shaped to cover at least a portion of the seat surface, the porous sheet having a seat panel, two leg panels extending from the seat panel, and a crotch flap extending from the seat panel and disposed between the two leg panels, wherein the porous material is selected to permit urine from a child situated in the child seat to pass through it;
a sheet of absorptive material shaped to cover at least a portion of the seat surface, the absorptive sheet having a seat panel, two leg panels extending from the seat panel, and a crotch flap extending from the seat panel and disposed between the two leg panels, wherein the absorptive material is selected to absorb the urine; and
a sheet of non-porous material shaped to cover at least a portion of the seat surface, the non-porous sheet having a seat panel, two leg panels extending from the seat panel, and a crotch flap extending from the seat panel and disposed between the two leg panels, the non-porous sheet coupled to the porous sheet with the absorptive sheet disposed therebetween, and the non-porous sheet having a bottom surface with high frictional characteristics to prevent slippage against the seat surface, wherein the non-porous material is selected to prevent the urine from leaking through it and soiling the child seat.

9. The child seat protector of claim 8, wherein the porous sheet, the absorptive sheet, and the non-porous sheet each have a body portion with a similar shape and size, the porous sheet and the non-porous sheet each have an edge portion with a similar shape and size, and the absorptive sheet has a plurality of edge tabs extending from the absorptive sheet body portion, wherein the porous sheet edge portion, the absorptive sheet edge tabs, and the non-porous sheet edge portion are coupled together.

10. The child seat protector of claim 8, further comprising a back panel extending from the seat panel opposite the leg panels.

11. The child seat protector of claim 8, wherein the porous sheet, the absorptive sheet, and the non-porous sheet are coupled together by stitching.

12. The child seat protector of claim 8, wherein the frictional bottom surface of the non-porous sheet has a texture, protrusions, or both.

13. The child seat protector of claim 8, wherein the porous sheet is made of terry cloth and the non-porous sheet is made of plastic.

14. The child seat protector of claim 8, wherein the porous sheet, the absorptive sheet, and the non-porous sheet are made of machine-washable materials.
